(19) United States
(12) Patent Application Publication
(10) Pub. No.: US 2019/0169000 A1
(43) Pub. Date: Jun. 6, 2019

(54) ELEVATOR CAR SEPARATOR FOR DIVIDED USE

(71) Applicant: Otis Elevator Company, Farmington, CT (US)

(72) Inventor: Nicolas Beaubois, Chatillon Sur Loire (FR)

(21) Appl. No.: 16/192,981

(22) Filed: Nov. 16, 2018

(30) Foreign Application Priority Data
Dec. 1, 2017 (EP) 17306680.4

(51) Int. Cl. B66B 11/02; B66B 1/52; B66B 1/50; B66B 9/00; B66B 11/00

(52) U.S. Cl. CPC B66B 11/0226; B66B 1/52; B66B 11/0005; B66B 9/00; B66B 1/50

(57) ABSTRACT

Elevator systems having an elevator car located within an elevator shaft, the elevator car moveable between a plurality of floors of a building, a passenger space divider located within the elevator car dividing the elevator car into a first passenger compartment and a second passenger compartment, a first car operating panel located within the first passenger compartment of the elevator car and having a plurality of buttons operable for selection of a destination floor of the plurality of floors, and a second car operating panel located within the second passenger compartment of the elevator car and having a plurality of buttons operable for selection of a destination floor of the plurality of floors.

### BACKGROUND

The subject matter disclosed herein generally relates to elevator systems and, more particularly, to elevator car separators for divided use of the elevator car.

Elevator cars can provide access to multiple floors or landings within a building. In some buildings, limited or authorized (e.g., restricted) access may be required for one or more of the landings/floors. In some buildings, different elevators can be used to provide public and private access, but in other buildings, such as ones with a single elevator car, restricting access can be problematic. One solution is to use keycard or similar authentication devices/methods, but such methods can still be worked around. Accordingly, improved systems for restricting access to certain floors/landings of a building may be desirable.

### SUMMARY

According to some embodiments, elevator systems are provided. The elevator systems include an elevator car located within an elevator shaft, the elevator car moveable between a plurality of floors of a building, a passenger space divider located within the elevator car dividing the elevator car into a first passenger compartment and a second passenger compartment, a first car operating panel located within the first passenger compartment of the elevator car and having a plurality of buttons operable for selection of a destination floor of the plurality of floors, and a second car operating panel located within the second passenger compartment of the elevator car and having a plurality of buttons operable for selection of a destination floor of the plurality of floors.

In addition to one or more of the features described herein, or as an alternative, further embodiments of the elevator systems may include that the plurality of floors includes at least one first landing, wherein the at least one first landing is only accessible from the first passenger compartment and not from the second passenger compartment.

In addition to one or more of the features described herein, or as an alternative, further embodiments of the elevator systems may include that the first car operating panel includes a button for selection of the at least one first landing as a destination floor, and the second car operating panel does not include a button for selection of the at least one first landing as a destination floor.

In addition to one or more of the features described herein, or as an alternative, further embodiments of the elevator systems may include that the plurality of floors includes at least one second landing, wherein the at least one second landing is only accessible from the second passenger compartment and not from the first passenger compartment.

In addition to one or more of the features described herein, or as an alternative, further embodiments of the elevator systems may include that the second car operating panel includes a button for selection of the at least one second landing as a destination floor, and the first car operating panel does not include a button for selection of the at least one second landing as a destination floor.

In addition to one or more of the features described herein, or as an alternative, further embodiments of the elevator systems may include that the first passenger compartment is accessible through a first elevator car door and the second passenger compartment is accessible through a second elevator car door.

In addition to one or more of the features described herein, or as an alternative, further embodiments of the elevator systems may include that a selection of destination floors within the first passenger compartment is different from a selection of destination floors within the second passenger compartment.

In addition to one or more of the features described herein, or as an alternative, further embodiments of the elevator systems may include that the plurality of floors of the building comprise one or more first landings and one or more second landings.

In addition to one or more of the features described herein, or as an alternative, further embodiments of the elevator systems may include that the passenger space divider comprises a frame support, a first compartment panel mounted to the frame support and located within the first passenger compartment, and a second compartment panel mounted to the frame support and located within the second passenger compartment.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3 is a schematic illustration of a car wall panel of an elevator system with a car operating panel that may employ various embodiments of the present disclosure;

FIG. 4 is a plan view illustration of an elevator system illustrating first and second side landings and entrances;

FIG. 5 is a schematic illustration of an elevator system in accordance with an embodiment of the present disclosure;

FIG. 6 is a schematic illustration of an elevator car in accordance with an embodiment of the present disclosure; and

FIG. 7 is a schematic illustration of an elevator car in accordance with an embodiment of the present disclosure.

### DETAILED DESCRIPTION

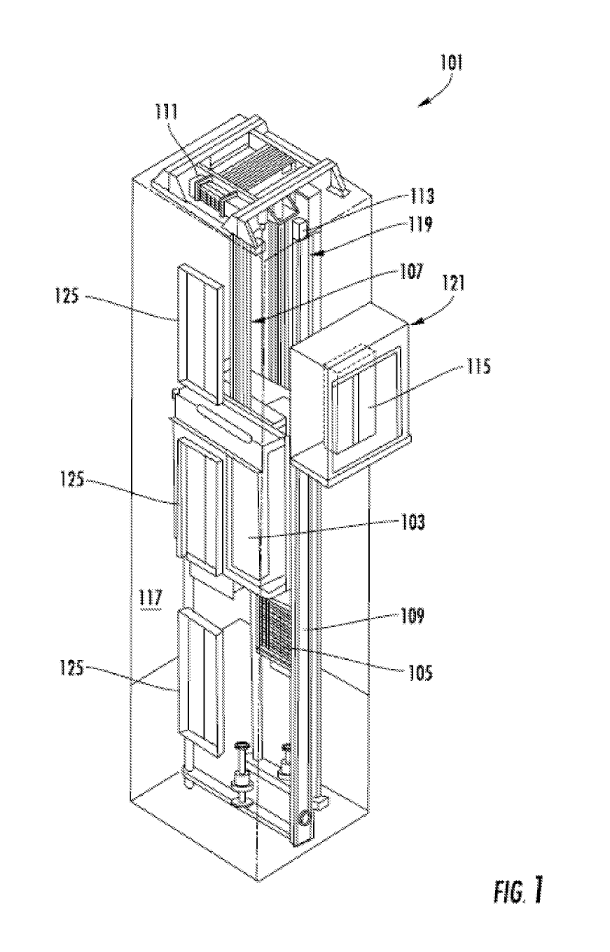

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes. It should be understood that the common platform user interface touch system may be used in any type of system where interaction or input is desired from a user.

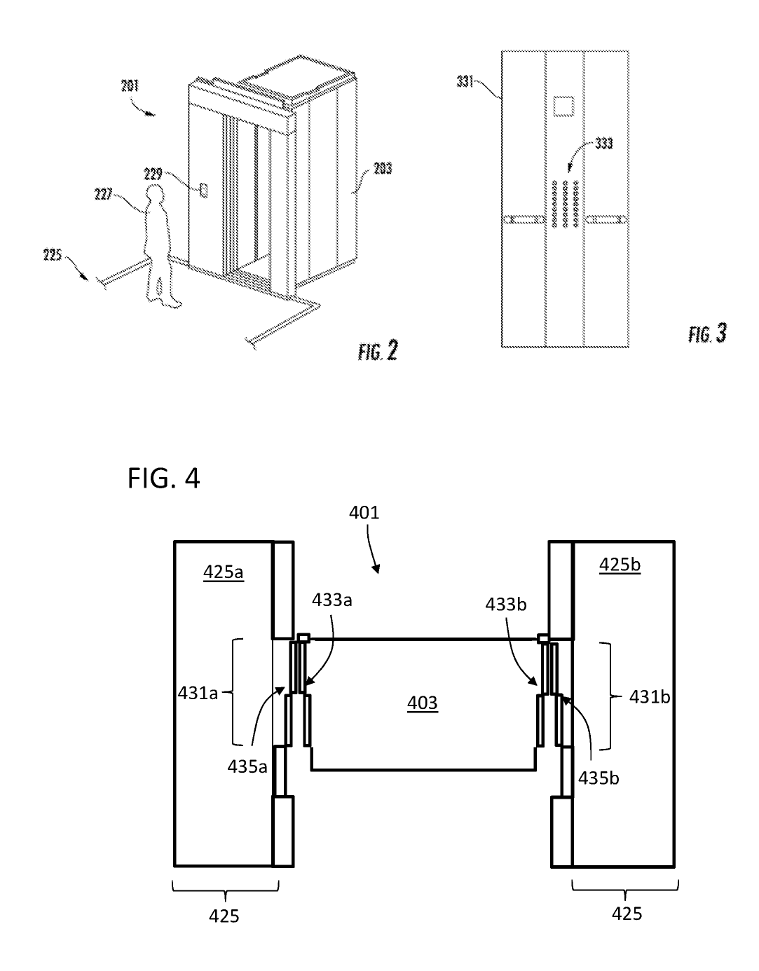

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger 227 that desires to travel to another floor within a building. The passenger 227 can call the elevator car 203 by pressing a call button on a hall call panel 229. The hall call panel 229 is in operable communication with an elevator controller (e.g., elevator controller 115 of FIG. 1) and can make a request such that an elevator car will stop at the landing 225. The hall call panel 229 can be used to request travel in a desired direction (e.g., up or down), as known in the art. When the elevator car 203 reaches the landing 225, one or more elevator doors, including elevator car doors and landing doors, may open, allowing the passenger 227 to enter or exit the elevator car 203.

FIG. 3 is a schematic illustration of an elevator car wall 331 that includes a car operating panel 333. The car operating panel 333, in traditional elevator system configurations, is a fixed, usually flat, and static operating panel that enables passengers to select floors to travel within a building and/or provide other operation (e.g., maintenance operations, emergency operations, etc.). That is, the car operating panel 333 may include one or more physical or mechanical buttons that are preset and fit with a particular physical layout. Typically, the car operating panel 333 is a standard component that can be installed in any number of locations (e.g., various different buildings) without much modification.

FIG. 4 illustrates a top down view of an elevator system 401 having an elevator car 403 located at a landing 425. As shown, the landing 425 has a first side 425a and a second side 425b. The different sides 425a, 425b of the landing 425 may be landings of the same or different sections of a building. For example, in some arrangements, the first side 425a may be a public access portion of a building, having shops, businesses, etc. and the second side 425b may be a private access portion of the building, having residences. When the elevator car 403 is located at the landing 425, a first elevator car door 433a is positioned adjacent a first landing door 435a at the first side 425a of the landing 425, and when opened form a first entrance 431a. Similarly, a second elevator car door 433b is positioned adjacent a second landing door 435b at the second side 425b of the landing 425, and when opened form a second entrance 431b. It may be advantageous to separate the access to the first and second sides 425a, 425b of the landing 425. That is, it may be useful to enable only authorized persons to access the second (private) side 425b of the landing 425. In such arrangements, separate access can be controlled by keycard or other authorization device. However, such mechanisms may still allow unauthorized access to the various floors where access should be denied.

In some building arrangements, certain landings/floors may be entirely designated as public or private, which provides additional separation of public and private access floors. In such buildings, access can again be controlled by keycard or similar device. However, controlled access cannot be ensured.

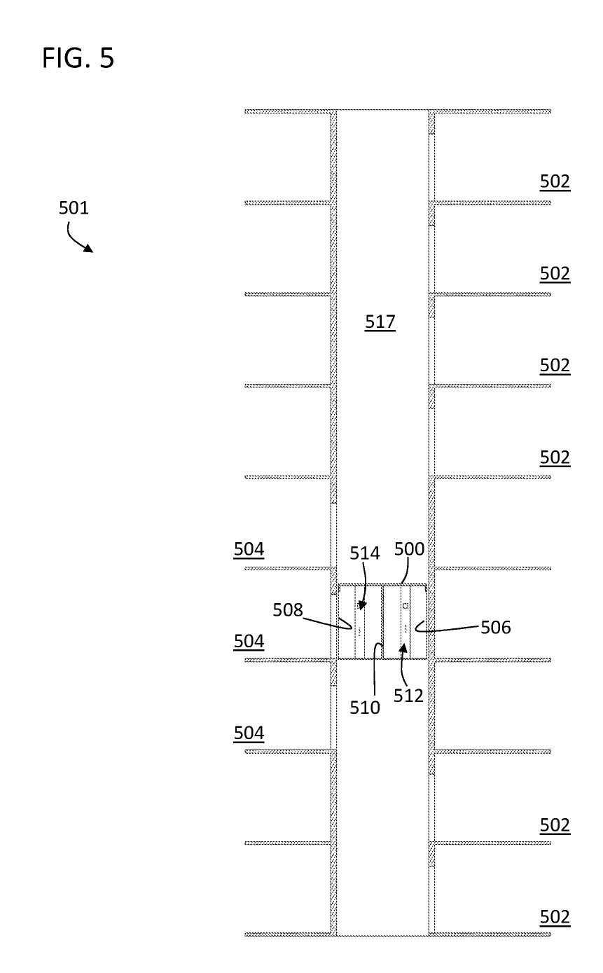

Accordingly, referring to FIG. 5, a schematic illustration of an elevator system 501 having a divided elevator car 500 of an embodiment of the present disclosure within an elevator shaft 517 is shown. The divided elevator car 500 is arranged to provide separate access to one or more first landings 502 and one or more second landings 504, using the single elevator car 500. The first landings 502 can be private access floors of a building, such as residential floors and associated private-access parking, whereas the second landings 504 can be public access floors of the building, such as business floors, a public lobby, and associated parking.

The elevator car 500 has two elevator car doors, on opposing sides of the elevator car 500. For example, as shown, the elevator car 500 has first elevator car door 506 and second elevator car door 508. The first elevator car door 506 is configured to only be opened at the first landings 502 and the second elevator car door 508 is configured to only be opened at the second landings 504. In this embodiment, the first landings 502 are completely separate from the second landings 504 such that when the elevator car 500 is located at a landing of a first landing 502 no access to a second landing is possible. That is, the landings 502, 504 are provided for specific floors.

To provide completely separate access to the first and second landings 502, 504, the elevator car 500 is divided by a passenger space divider 510. The passenger space divider 510 is a physical structure, such as a wall or panel, within the elevator car 500 that physically separates a first passenger compartment 512 from a second passenger compartment 514. Passengers within the first passenger compartment 512 can operate the elevator car 500 to travel to the first landings 502 (without access to the second landings 504) and passengers within the second passenger compartment 514 can operate the elevator car 500 to travel to the second landings 504 (without access to the first landings 502).

Although shown in FIG. 5 with a specific arrangement, those of skill in the art will appreciate that embodiments provided herein are not so limited. For example, in some embodiments, one or more floors can be accessible from both the first and second passenger compartments 512, 514 (e.g., a public lobby with keycard access to the first elevator car door 506 required at the public landing).

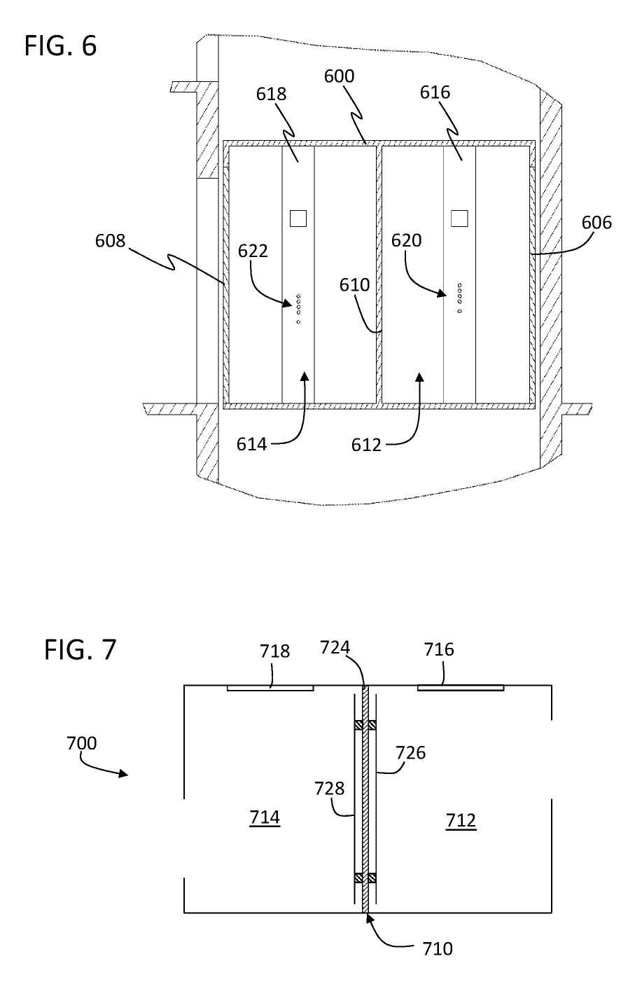

Turning now to FIG. 6, a schematic illustration of an elevator car 600 in accordance with an embodiment of the present disclosure is shown. The elevator car 600 is a divided elevator car with a first passenger compartment 612 separated from a second passenger compartment 614 by a passenger space divider 610, similar to that described with respect to FIG. 5. The first passenger compartment 612 has a dedicated first elevator car door 606 providing ingress/egress into and out of the first passenger compartment 612. Similarly, the second passenger compartment 614 has a dedicated second elevator car door 608 providing ingress/egress into and out of the first passenger compartment 614.

To provide control of the elevator car 600, the elevator car 600 includes two separate and distinct car operating panels. For example, as shown in FIG. 6, the elevator car 600 includes a first car operating panel 616 located in the first passenger compartment 612 and a second car operating panel 618 located in the second passenger compartment 614. The car operating panels 616, 618 are electrically connected to an elevator controller to enable elevator destination floor requests and other typical features provided by elevator car operating panels. The first car operating panel 616 includes first car operating buttons 620 and the second car operating panel 618 includes second car operating buttons 622. In some embodiments, the first car operating buttons 620 and the second car operating buttons 622 are configured to provide different functionality to the elevator car 600. For example, in some embodiments, the first car operating buttons 620 may be buttons to provide access to a first subset of landings/floors of a building that are accessible from the first passenger compartment 612. Similarly, the second car operating buttons 622 may be buttons to provide access to a second subset of landings/floors of the building that are accessible from the second passenger compartment 614.

The passenger space divider 610, in some embodiments, may be a fixed wall or structure that physically defines and separates the first passenger compartment 612 and the second passenger compartment 614. In some embodiments, the passenger space divider 610 can be a frame with one or more elevator interior wall panels, thus providing a desired aesthetic to the interior of the elevator car 600.

Turning to FIG. 7, a plan view illustration of an elevator car 700 in accordance with an embodiment of the present disclosure is shown. The elevator car 700 is a divided elevator car similar to that shown and described above, having a first passenger compartment 712 and a second passenger compartment 714. The first passenger compartment 712 includes a first car operating panel 716 and the second passenger compartment 714 includes a second car operating panel 718. In this embodiment, a passenger space divider 710 is shown as comprising a frame support 724, a first compartment panel 726, and a second compartment panel 728. The first and second compartment panels 726, 728 are mounted to the frame support 724 and can be interchangeable and/or customizable to provide an aesthetic to the elevator car 700.

Advantageously, embodiments provided herein are directed to elevator systems that provide a mechanical or physical barrier to prevent unauthorized access to specific floors/landings of a building.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator system comprising:
an elevator car located within an elevator shaft, the elevator car moveable between a plurality of floors of a building;
a passenger space divider located within the elevator car dividing the elevator car into a first passenger compartment and a second passenger compartment;
a first car operating panel located within the first passenger compartment of the elevator car and having a plurality of buttons operable for selection of a destination floor of the plurality of floors; and
a second car operating panel located within the second passenger compartment of the elevator car and having a plurality of buttons operable for selection of a destination floor of the plurality of floors.

2. The elevator system of claim 1, wherein the plurality of floors includes at least one first landing, wherein the at least one first landing is only accessible from the first passenger compartment and not from the second passenger compartment.

3. The elevator system of claim 2, wherein the first car operating panel includes a button for selection of the at least one first landing as a destination floor, and the second car operating panel does not include a button for selection of the at least one first landing as a destination floor.

4. The elevator system of claim 1, wherein the plurality of floors includes at least one second landing, wherein the at least one second landing is only accessible from the second passenger compartment and not from the first passenger compartment.

5. The elevator system of claim 4, wherein the second car operating panel includes a button for selection of the at least one second landing as a destination floor, and the first car operating panel does not include a button for selection of the at least one second landing as a destination floor.

6. The elevator system of claim 1, wherein the first passenger compartment is accessible through a first elevator car door and the second passenger compartment is accessible through a second elevator car door.

7. The elevator system of claim 1, wherein a selection of destination floors within the first passenger compartment is different from a selection of destination floors within the second passenger compartment.

8. The elevator system of claim 1, wherein the plurality of floors of the building comprise one or more first landings and one or more second landings.

9. The elevator system of claim 1, wherein the passenger space divider comprises a frame support, a first compartment panel mounted to the frame support and located within the first passenger compartment, and a second compartment panel mounted to the frame support and located within the second passenger compartment.
